(19) United States
(12) Patent Application Publication
(10) Pub. No.: US 2022/0245632 A1
(43) Pub. Date: Aug. 4, 2022

(54) TRANSACTION SUCCESS PREDICTIONS

(71) Applicant: Wells Fargo Bank, N.A., San Francisco, CA (US)

(72) Inventors: Stephen G. Nicholson, Pleasant Hill, CA (US); Alma D. Jensen, Castro Valley, CA (US); Linda Huang, San Francisco, CA (US); Peter S. Kim, Belmont, CA (US)

(21) Appl. No.: 17/247,062

(22) Filed: Nov. 25, 2020

Related U.S. Application Data
(63) Continuation of application No. 14/874,825, filed on Oct. 5, 2015, now abandoned.

(51) Int. Cl. G06Q 20/40

(52) U.S. Cl. CPC G06Q 20/40

(57) ABSTRACT

A method for providing user feedback and recommendations regarding the likelihood that a fund transfer transaction will be completed can include receiving a first message and a second message, from an external device, that includes first transaction data and second transaction data for a proposed transaction. The method can further include generating a first assessment and a second assessment, responsive to receiving the first message and the second message and based at least in part on the first transaction data and the second transaction data, of the likelihood that the transaction will be successful if initiated. The method can further include providing user feedback to the external device to indicate the likelihood. Other systems, apparatuses, and methods are also described.

### CROSS-REFERENCE TO RELATED APPLICATION

This application is a continuation of U.S. patent application Ser. No. 14/874,825, filed Oct. 5, 2015, which is incorporated by reference herein in its entirety.

### BACKGROUND

Banking account holders often complete financial transactions online, using Web-based forms to enter financial transaction details. These forms can be time-consuming to complete, especially in the case of complex international fund transfers.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 illustrates a block diagram of a system in which any one or more of the techniques (e.g., methodologies) discussed herein can be performed, according to an example embodiment;

FIG. 2 is a block diagram of an assessment system, according to an example embodiment;

FIG. 3 illustrates a method of assessing the likelihood that a financial transaction will be successfully completed, according to an example embodiment;

FIG. 4 illustrates a method for completing a financial transaction when likelihood of success assessments are provided, according to an example embodiment;

FIG. 5 illustrates example user interface fields that a user can use for providing visual indicators of likelihood of financial transaction success, according to an example embodiment;

FIG. 6 illustrates an alert box for presenting an alert regarding an attempted financial transaction, according to an example embodiment; and

FIG. 7 is a block diagram illustrating an example machine upon which any one or more of the techniques (e.g., methodologies) discussed herein can be performed, according to an example embodiment.

### DETAILED DESCRIPTION

Efficient use could be made of an account holder's time, and possible causes of frustration could be avoided, if electronic banking systems provided feedback on the likelihood of transaction success to account holders at the same time these account holders were providing transaction details online. Systems and methods disclosed herein relate to electronically assessing the likelihood that a financial transaction can be completed, based on analysis of various transaction parameters entered in an online user form. Systems in accordance with various embodiments can provide feedback and suggestions, in real time while the user is still entering transaction details, for remedying errors that can lead to failures in financial transactions. Some embodiments apply to fund transfer transactions, such as wiring of funds, although embodiments can be applied to any transaction between two accounts, to a transaction for opening an account, loan applications, etc.

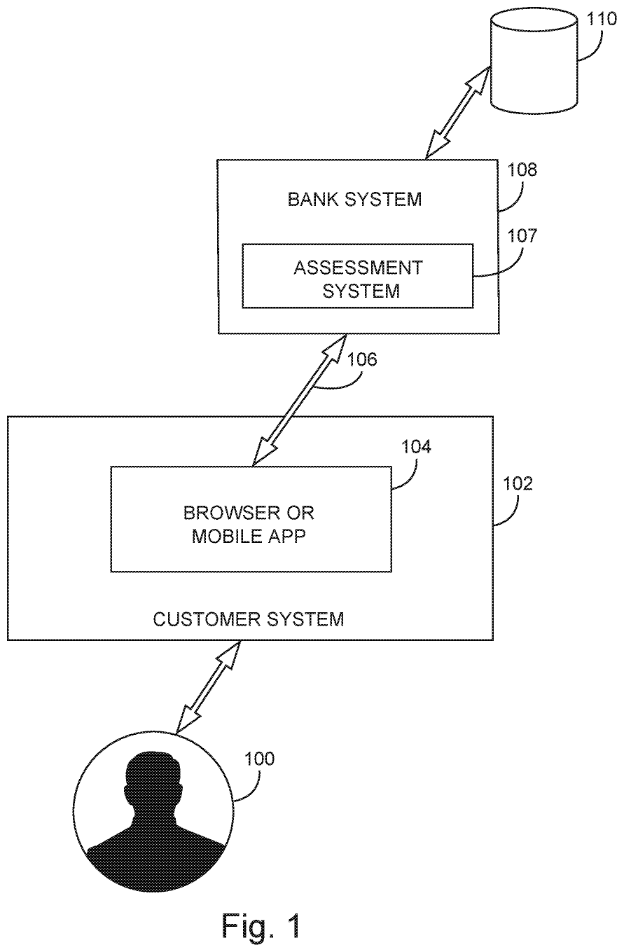

FIG. 1 illustrates a block diagram of a system in which any one or more of the techniques (e.g., methodologies) discussed herein can be performed, according to an example embodiment. As illustrated in FIG. 1, a user 100 uses a customer system 102 to perform financial transactions. The customer system 102 can include a desktop computer, mobile device, automated teller machine (ATM), wearable device, etc. Mobile devices can include various wireless devices that can communicate with the bank system 108. For example, a mobile device can include cellular telephones, smart phones, handheld personal communication devices, laptops, tablet computers, etc.

The customer system 102 includes a browser or mobile application 104 to allow the user 100 to conduct fund transfers via the Internet or other network connection 106. The customer system 102 can provide payment and transaction information to the bank system 108 via a bank website displayed in the browser or mobile application 104. For example, the customer system 102 can provide bank account information or credit card account information, payee details, etc., to the bank system 108 via the browser or mobile application 104.

The bank system 108 can be owned and maintained at one or more financial institutions (e.g., banks, credit unions, savings and loan associations, and other institutions maintaining accounts) to access accounts held at the respective financial institutions. Similarly, a payee (not shown in FIG. 1) can receive payment from the bank system 108. The browser or mobile application 104 can display a representation of the status of a financial transaction as described below, during one or more phases of the financial transaction, in real time or near real time.

The bank system 108 has access to account balances for account holders, in addition to various types of personal information about account holders. For example, most banks or financial institutions have access to credit records for account holders and to transactional history for account holders, so that the bank or financial institution can flag problematic transactions. The bank system 108 can access this or other data by retrieving the data from bank system data storage 110.

In addition to data regarding account holders, most banks and other financial institutions have access to regulatory data, governmental records, governmental blacklists, etc., that can hold information regarding payees or beneficiaries of a proposed financial transaction. The bank system 108 can flag or prevent transactions with, for example, participants of terrorist organizations, bank accounts in countries with which a trade embargo is in place, etc. In some embodiments, an assessment system 107 assesses the probability that a transaction can be carried out successfully, in light of the various issues and problems that can occur on either the payee or payor side of the transaction.

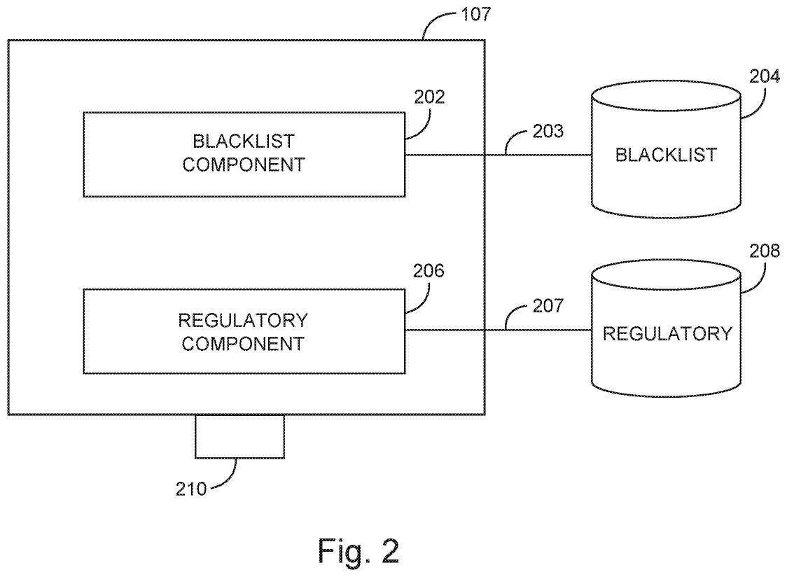

FIG. 2 is a block diagram of an assessment system 107, according to an example embodiment. The assessment system 107 can include one or more components that define and apply assessments to transaction data provided by a customer system 102 and that relate to a particular transaction. The assessment system 107 can perform assessment on a real-time basis while the user 100 enters information in an online form on the browser or mobile application 104.

In some embodiments, the assessment system 107 calculates a probability of success as the customer system 102 transmits each piece of data related to the transaction. For example, the assessment system 107 can generate an assessment upon receiving the payee name, and the assessment system 107 can generate another (or update the first) assessment upon receiving the transaction amount from the customer system 102. The assessment system 107 can provide each individual assessment separately, as a probability, grade, score, etc., to be displayed separately for each piece of transaction data or each type of transaction data. In addition or alternately, a weighted assessment can be generated at the assessment system 107 to combine various assessments based on relative importance of the different types of transaction data. The assessment system 107 can provide the weighted assessment for display as described later herein. In some embodiments, an assessment will determine that the transaction cannot succeed if initiated, even if the customer system 102 provides amended transaction data, and in these instances, the assessment system 107 will halt any further attempts to complete the transaction. For example, a message may be presented to a user on the browser or mobile application 104 that informs the user to stop entering in information unless the piece of data that triggered the halt is changed.

The assessment system 107 can include one or more processors that implement or execute various assessment components and algorithms. For example, the processor can implement a blacklist component 202 that compares the entered data against a blacklist 204 of entities for whom transactions are restricted or to be blocked. In addition, the assessment system 107 can include a regulatory component 206 to define standard business rules applicable to transactions, such as requiring proof of identity for any transaction over a given value, or for checking governmental regulations regarding embargos or other types of governmental regulations.

The assessment system 107 can include other components (not shown in FIG. 2) to access account-related data to identify other transactions that can be linked to the same account or associated user (e.g., by associating similar names, addresses and other identifying data) or for accessing and analyzing account history for accounts, on either the payee or payor side of the transaction. Accordingly, the assessment system 107 can consider the currently requested transaction, including transaction amount, sufficiency of funds, etc., as well as analyzing trends for the payor account, and multiple data categories and data sources beyond those described herein can be considered in assessing the likelihood of success of the current transaction. For example, the assessment system 107 can generate a more complete profile that considers employment records, criminal and court records, marital records, etc., to generate a profile for at least one user associated with the payor account, the payee account, or both the payor and payee account. If a red flag or other alert is raised with any of these data sources, the assessment system 107 can provide an alert to be displayed as a visual or audio indicator.

In sonic embodiments, rules implemented in the assessment system 107 can be developed and refined over time based on transaction data, including data for prior transactions. For example, the assessment system 107 can detect user patterns based on historical trends for the payor account, the payee account, or personal data for the payor or payee. The assessment system 107 can use those user patterns to generate rules for determining when a transaction is likely fraudulent. If the user patterns change (e.g., employment data indicates the payor may have greater funds, and accordingly higher transaction amounts, or the user has confirmed that certain transactions flagged as fraudulent were not in fact fraudulent), then the assessment system 107 may update rules to trigger fraud alerts at higher transaction amounts or at different values for other parameters.

The assessment system 107 can perform operations upon or at some point subsequent to receiving messages from the customer system 102 to provide user feedback in real time, thereby allowing a user to remedy any deficiencies or erroneous inputs, or to be informed that a transaction is not likely to go through. In some embodiments, the user feedback can be provided for each field on a browser screen or banking application, as described later herein. The assessment system 107 includes at least one network port 210 to communicate with an external device (e.g., the customer system 102) and to communicate with other components of the bank system 108 (FIG. 1).

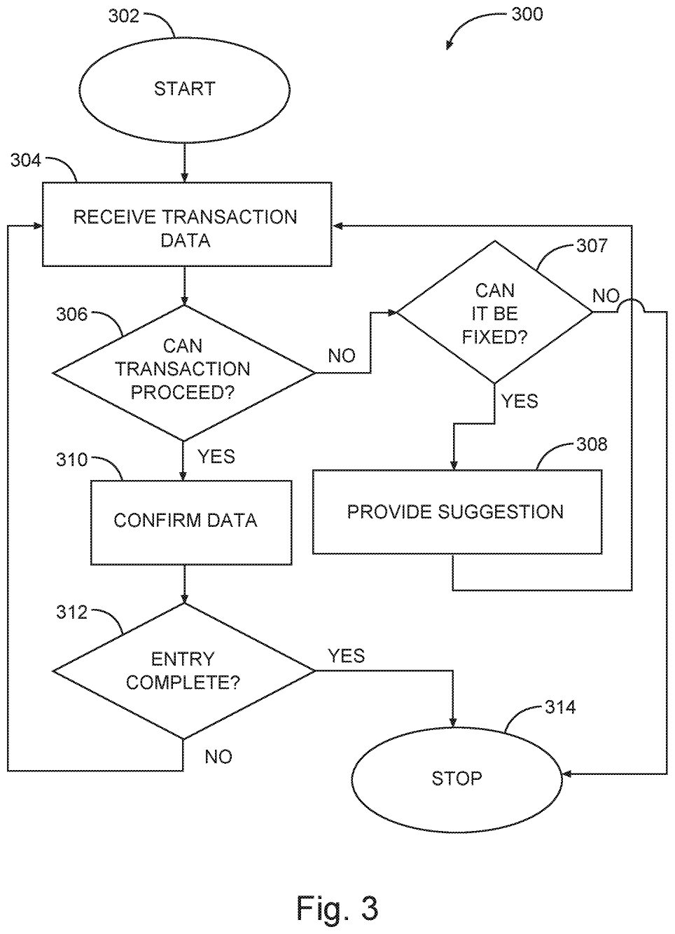

FIG. 3 illustrates a method 300 of assessing the likelihood that a financial transaction will be permitted or successfully completed according to an example embodiment. A bank system 108, including components of the assessment system 107 or other bank system 108 components or databases, can perform one or more of the operations of method 300. The assessment system 107 can assign a score, grade, probability, etc., using transaction parameters such as amounts, etc., indicated by the user.

The example method 300 begins at operation 302, which can be triggered or initiated with a user 100 (FIG. 1) logging into a payor account, entering a personal identification number (PIN), etc., on a customer system 102 (e.g., ATM machine, laptop computer, desktop computer, mobile device, etc.) external to the bank system 108. The user 100 can then request a transaction, such as a fund transfer transaction, from the payor account to a payee account.

While some embodiments herein are discussed with respect to fund transfer transactions, it will be appreciated that embodiments are not limited thereto, and some operations can apply to other types of financial transactions such as, by way of a non-limiting example, loan applications, etc.

The example method 300 continues with operation 304 with the assessment system 107 receiving a message, from an external device (e.g., the customer system 102), that includes transaction data for a proposed transaction that has been proposed on the customer system 102. When the transaction includes a fund transfer transaction, the transaction data can include at least one of a transaction amount, a payee name, a payee address, a payee account number, and a payor account number.

The example method 300 continues with operation 306 with the assessment system 107 generating an assessment, responsive to receiving the message and based at least in part on the transaction data provided in operation 304, of the likelihood that the transaction will be permitted. In the context of example embodiments, a transaction is permitted when the transaction would be successful, (e.g., “go through”) if initiated as submitted at the requested amount, to the requested payee, and at any other transaction parameter requested in operation 304. If the transaction data provided in operation 304 includes a transaction amount or a payor account, the assessment system 107 can determine whether there are sufficient funds in the payor account to complete the transaction, based on the transaction amount.

The assessment system 107 can generate assessments by first retrieving data from various sources, including the bank system 108 databases, governmental databases, a check verification database, Automated Clearing House (ACH) database, etc. The assessment system 107 can also access a governmental, law enforcement, or banking industry association fraud database, to determine whether a payor is attempting to transfer funds to a payee name or payee account identified as being associated with a fraud scheme. The assessment system 107 can retrieve data using a secured network connection or a non-secured network connection. The assessment system 107 can perform analysis or operations as part of generating the assessment. For example, the assessment system 107 can perform credit checks to generate a credit history, and the assessment system 107 can access, generate, or analyze other historical data and trends. For example, the assessment system 107 can perform analysis of other categories of data including employment history, property ownership records, income history, marital history, etc., and generate an alert or other feedback responsive to detecting an adverse condition in at least one of these categories.

By analyzing historical data and trends, the assessment system 107 can determine usual spending behavior from the payor account. For example, the assessment system 107 can analyze typical transaction amounts, typical payees, typical time of month of various payments, liquidity, etc. Therefore, assessment can include accessing historical data for transactions against the payor account to determine a historical threshold (e.g., average, absolute, etc.) for transaction amounts, and generating an alert if the transaction amount is above the historical threshold. In some embodiments, assessment can include determining, based on the historical data, whether a payee indicated in the payee name has previously received funds from the payor account, and providing the user feedback comprises generating an alert if the payee has not previously received funds from the payor account.

Some payor accounts can be associated with low credit lines, such that transactions will only be allowed in lowered amounts or at different frequencies relative to that which is allowed to other bank customers with higher credit lines or more favorable credit histories. Accordingly, the assessment system 107 can set an upper threshold for transaction amounts based on a credit worthiness assessment associated with the payor account, and provide user feedback indicating that the transaction cannot proceed if the transaction amount is greater than the upper threshold. As part of the credit worthiness assessment or historical trend assessment, the assessment system 107 can generate or access aggregate sums of fund transfers requested in connection with the payor account to ensure that a requested transaction will not overdraw the payor account.

The assessment system 107 can use a check verification database or ACH database to perform verifications against the payor account. The assessment system 107 can use the check verification database to detect history of “bad” checks for the payor, or the payee. In at least these embodiments, likelihood of success of a transaction can be lowered, and a visual indicator can indicate a lower likelihood of success, if the check verification database indicates history of a large number of bad checks, where the number used can be adjusted by the financial institution.

The assessment system 107 can generate similar fraud alerts and likelihood of success predictions based on data retrieved from an ACH database. ACH is an electronic payment network for funds transfer, in which a transaction begins at an originator, is passed to an Originating Depository Financial institution (ODFI) and through an ACH Operator to Receiving Depository Financial Institutions (RDFIs). Each RDFI receives entries for its customer accounts and posts entries on the settlement date. Embodiments can allow an account holder to be notified of a possible overdraft situation or fraud condition while entering transaction details, rather than waiting until the settlement date for notification. For example, the assessment system 107 can detect possible fraud or a lowered likelihood of success if a larger-than-usual. number of ACH transactions are initiated against one payor account or against one financial institution, based on data retrieved from ACH databases. A financial institution can separately adjust the number or amounts of ACH transactions that can occur for payor accounts, so that fraud alerts, overdraft warnings, etc., can be generated in real-time in accordance with various embodiments.

If the transaction data includes a payee address, the assessment system 107 can generate an assessment based on the currency type or location (e.g., address, country, etc.) of the payee. This can provide data as to whether currency fluctuations at the payee location are such that only reduced or lowered transaction amounts should be permitted. In some embodiments, the assessment system 107 can generate an assessment of foreign exchange risk (e.g., FX risk, exchange rate risk, or currency risk) when a financial transaction is to be completed at the payee account in a base currency other than that of the base currency of the payor account. In these embodiments, the assessment system 107 assesses the risk of an adverse fluctuation in the exchange rate in the base currency of the payee account before the transaction is completed. When assessing based on location, the assessment system 107 can assess whether embargo information indicates that transactions are not permitted with accounts at a country indicated in the payee address. The assessment system 107 can retrieve embargo information from governmental databases, or from databases local to or owned by the bank system 108.

The assessment system 107 can generate an assessment based on the payee name. In some embodiments, an assessment based on the payee name can include determining whether the customer system 102 has provided a complete name. In at least these embodiments, the assessment system 107 can provide user feedback if, for example, a last name is needed, or other identification information is needed for the payee. In some embodiments, providing user feedback includes providing an indication that the transaction is prohibited if at least one of the payee name and the payee account number is included in a governmental blacklist. For example, a payee name can include, or be an alias of, the name of a person known to be associated with money laundering, such that any transactions to or from that person are to be prohibited or prevented.

In at least some embodiments, the assessment system 107 can provide user feedback based on assessment of data accessed in a governmental, law enforcement, or banking industry association fraud database, to determine whether a payor is attempting to transfer funds to a payee name or payee account identified as being associated with a fraud scheme, In at least these embodiments, a fraud warning can be displayed, the transaction can be prevented completely, or a likelihood of success metric can be lowered by a certain percentage indicating a lower likelihood of success while still (potentially) allowing the transaction to proceed if further negative indicators are not present. Governmental officials, law enforcement officials, or banking institutions can be notified, with or without informing the payor, of potential fraud based on assessment system 107 detection of potential fraud.

The example method 300 continues by providing user feedback to the customer system 102 to indicate the likelihood that the proposed transaction will succeed. In at least one embodiment, if the transaction cannot proceed, the example method 300 continues with operation 307 by determining whether the transaction data can be amended to permit the transaction to proceed. if so, in operation 308, the assessment system 107 provides a suggestion for amending the transaction data such that the transaction can proceed. For example, if a request is received customer system 102 for a fund transfer of $10,000, but the associated payor account has a balance of only $5000 in the account, the assessment system 107 can provide an indication to the customer system 102 that the transaction will be cancelled unless a smaller amount is entered (unless there is a credit line associated with the payor account, or there is some other extenuating circumstance). In some embodiments, if the transaction cannot proceed and the transaction data cannot be amended to remedy the problem, the example method 300 can include informing the user 100 that the transaction cannot proceed at operation 314, with or without providing a reason.

If the transaction can proceed, based on the assessment of the transaction data provided in operation 304, the example method continues with operation 310 with confirmation of the transaction data. This confirmation can include updating a database record to include the transaction data, providing a “green light” or other feedback to the user for display in a user interface such as the browser or mobile application 104 (FIG. 1), etc.

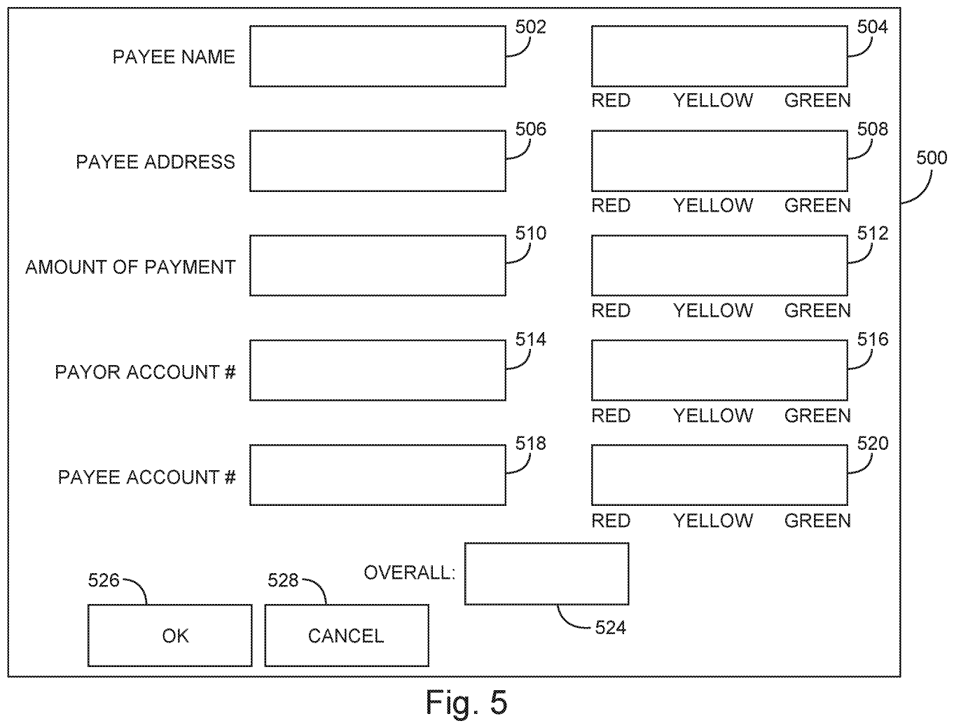

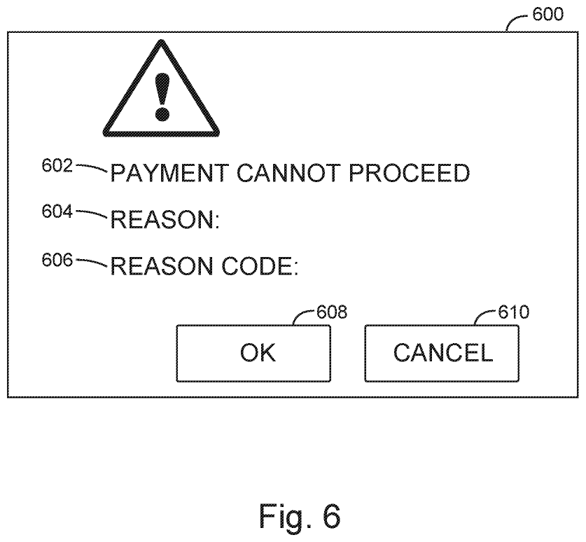

Transaction data can be provided to the bank system 108 is several separate messages from the customer system 102. The assessment system 107 can generate an assessment of the likelihood that the transaction can proceed responsive receiving each message, using the corresponding transaction data for that message. The transaction data may be of the same or different type in each message. For example, a first message can include a transaction amount, and a subsequent second message can include another transaction amount or other data such as a payor account number. Accordingly, the assessment system 107 can provide user feedback assessing each field of transaction data. An example of this feedback, and the fields of transaction data, are shown below in FIGS. 5 and 6, described later herein.

The example method 300 continues with operation 312 by determining whether transaction data entry is complete. This determination can be made based on messaging from the customer system 102. For example, the customer system 102 can pass on a message handler to the bank system 108 indicating that the user 100 has accepted all transaction parameters and wishes to proceed. If transaction data entry is complete, in operation 314, the bank system 108 can process the transaction, which can include performing the actual fund transfer to the payee account in some embodiments, or scheduling the transaction to occur later subject to final approval. In some embodiments, the bank system 108 can save transaction data to a database for immediate or future processing of the transaction. In some embodiments, if the transaction cannot be processed, the example method 300 can include providing an indication that the transaction cannot be processed with or without providing a reason, generating correspondence informing the holder of the payor account that the transaction cannot be processed, generating a report to a government agency, bank officer, etc., or any other similar operation.

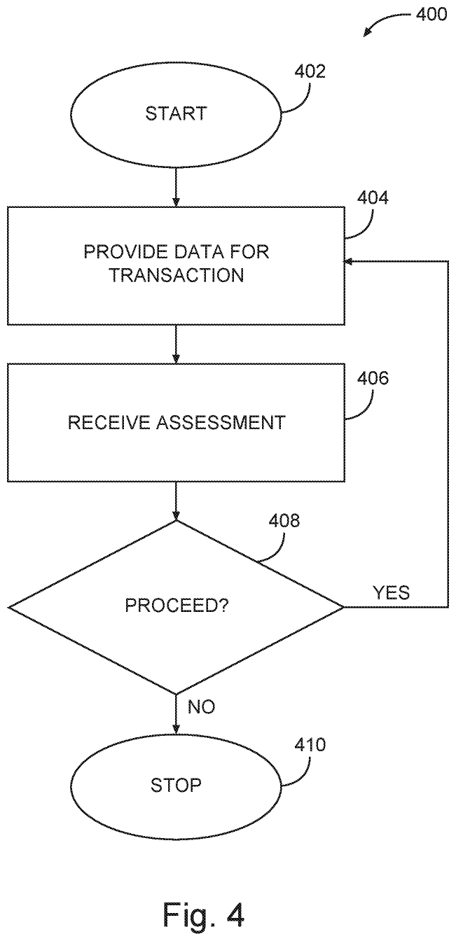

FIG. 4 illustrates a method 400 for completing a financial transaction when likelihood of success assessments are provided, according to an example embodiment. At least some of the operations of the example method 400 can be completed by components of the customer system 102, for example, by the browser or mobile application 104, in accordance with instructions stored in a non-transitory computer-readable storage medium for execution by a processor of the customer system 102.

The example method 400 begins with operation 402 with the user 100 (FIG. 1) logging into a payor account, entering a PIN, etc., on a customer system 102 (e.g., ATM machine, laptop computer, desktop computer, mobile device, etc.) as described above with respect to FIG. 3, operation 302. As discussed above with respect to FIG. 3, the user 100 can then request a transaction, for example a fund transfer transaction.

The example method continues with operation 404 with the customer system 102 providing data for a proposed transaction and operation 406, with the customer system 102 receiving an assessment of the likelihood that the proposed transaction can be completed using the data provided in operation 406. At operation 408, if the proposed transaction can proceed, and if the customer system 102 has not finished providing all transaction data, the customer system 102 can resume providing transaction data at operation 404. Otherwise, the example method 400 terminates at operation 410, and the bank system 108 (FIG. 1) can process the transaction, which can include performing the actual fund transfer to the payor account in some embodiments, or indicating that the transaction cannot be processed, with or without providing any additional reason.

FIG. 5 illustrates example user interface 500 fields that a user 100 can use for providing data according to operation 404 and for displaying assessments according to operation 406. The user interface 500 can be displayed using browser or mobile application 104 (FIG. 1) by way of a non-limiting example. The bank system 108 may communicate with internal databases or file servers to publish or serve files via a web server. The bank system 108 may include a web server. The web server may consist of scripts, applications, or library files that provide primary or auxiliary functionality to the web server (e.g., multimedia, file transfer, or dynamic interface functions). The web server, either alone or in conjunction with one or more other computers in the bank system 108, may provide the user interface 500. The user interface 500 may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, (Java™ Foundation Classes), and Swing (an Application Programming interface for Java™).

The example user interface 500 can include a variety of fields for entering information for completing a fund transfer transaction. The fields can be implemented as text boxes, lists, or any other type of user interface component capable of receiving a user input. Software on either the customer system 102, browser or mobile application 104, assessment system 107, etc., can perform data integrity checks or normalization procedures on data entered into these fields. For example, the customer system 102 can implement normalization or data integrity to ensure that the payee name field 502 does not include numerical digits, or that the transaction amount field 510 includes only numerical digits. As another example, transaction amounts and other monetary amounts can be processed in dollar equivalents at the bank system 108, and the customer system 102 can convert monetary amounts entered in the transaction amount field 510 to dollars before transmission of the transaction amount to the bank system 108. Furthermore, text strings entered into any of the fields can be converted into normalized formats for storage in any of the databases described herein.

The user interface 500 can include at least one payee name field 502, at least one payee address field 506, transaction amount field 510, a payor account number field 514, a payee account number field 518 or any other field pertinent to the type of transaction that the customer system 102 is attempting. The user interface 500 can further include visual indicators 504, 508, 512, 516, and 520 to indicate likelihood of success associated with each of the payee name field 502, the payee address field 506, the transaction amount field 510, and the payor account number field 514, respectively.

The visual indicators 504, 508, 512, 516 and 520 can be provided in various ways in various embodiments. For example, in some embodiments, values can be retrieved from fields 502, 506, 510, 514, 518, or other pertinent field using AJAX (for example). In at least these embodiments, the assessment system 107 can retrieve the visual indicators 504, 508, 512, 516 and 520, or identification information thereof, from a database that associates various retrieved values for field 502, 506, 510, 514, 518 or any other field, to corresponding visual indicators. In embodiments, a database can store information to indicate that a retrieved value from field 502, 506, 510, 514, 518 is associated with, for example, a 100% likelihood that a proposed transaction cannot proceed. In at least these embodiments, a visual indicator of “red” may be provided within the database, and retrieve from the database for corresponding visual indicator 504, 508, 512, 516, and 520. In embodiments, a database can store information to indicate that a given value for any or all of the fields 502, 506, 510, 514, 518 or any other field is associated with a 10-point increase, or other size increase, in the likelihood that a transaction cannot succeed, and the assessment system 107 can adapt or provide the visual indicator 504, 508, 512, 516 and 520 as each particular value is retrieved using AJAX.

In some embodiments, the assessment system 107 can compute a weighted likelihood that a transaction cannot succeed, by combining more than one likelihood value according to any algorithm or criteria. Accordingly, the assessment system 107 can generate a weighted visual indicator that combines likelihood of success for the transaction request. For example, any field can carry a greater weight than any other field, as shown in Equation (1):

0.5a+0.1b+0.3c+0.1d=likelihood (%) of success (1)

where 0.5 is an example weight assigned to the likelihood a (expressed as a percentage) that a transaction will succeed if initiated using the value corresponding to the transaction amount. 0.1 is an example weight assigned to the likelihood h that a transaction will succeed if initiated using the value corresponding to the payee name. 0.3 is an example weight assigned to the likelihood c that a transaction will succeed if initiated using the value corresponding to the payee address. 0.1 is an example weight assigned to the likelihood d that the transaction will succeed if initiated using the value corresponding to the payee account number. As can be appreciated, changes in the probability a will have a greater effect on the overall likelihood of success given in the example weighting Equation (1) than would changes in, for example, the probability b. It will also be appreciated that weighting algorithms according to various embodiments are not limited to the example shown in Equation (1). On the contrary, any weights can be assigned, and any number of fields or factors can be used, in determining a weighted likelihood of success.

In an example, the visual indicators are selected from a group consisting of a text box indicating a score, a text box indicating a grade, a color, a message box, and a combination of two or more types of visual indicators. For example, the likelihood of success visual indicator 504 associated with the payee name field 502 can include a color value of red if only a last name is provided, and a color value of green if a full name is provided for a party not on any sanctions list.

By way of additional example, the likelihood of success indicator 508 associated with the payee address field 506 can indicate a color of red if the payee address is within a known terrorist state, and color value of green if the payee address is complete and not flagged by any governmental system or other system. A country corresponding to the payee address field 506 may involve higher risk of illegal activity, or be subject to large currency fluctuations.

By way of additional example, the likelihood of success visual indicator 512 associated with the transaction amount field 510 can include a color value of green if the account history and account balance indicate that the transaction can proceed at the requested amount of payment. The likelihood of success indicator 512 associated with the transaction amount field 510 can indicate a color of red if the amount of the transaction is greater than an account balance of the payor account for the transaction.

The user interface 500 can display an overall likelihood of success visual indicator 524 for the transaction, and this visual indicator 524 can be a weighted average of any or all of the values for likelihood of success determined for fields 502, 506, 510, 514, 518, and corresponding to visual indicators 504, 508, 512, 516 or 520. User interface buttons 526 and 528 can allow the user 100 to continue with the transaction using the entered values in fields 502, 506, 510, 514 or 518 or to cancel the entire transaction request. The above examples do not limit example embodiments to any particular rating mechanism, fields, indications, or user interfaces. On the contrary, various embodiments can include fewer or more fields of different types as those shown in FIG. 5.

The customer system 102 can provide messages to the bank system 108 including transaction data corresponding to each of the fields 502, 506, 510, 514 or 518, or a single message can include transaction data for two or more of the fields 502, 506, 510, 514 or 518. In response, the bank system 108 can provide user feedback for each message or for a combination of two or more messages, and visual indicators 504, 508, 512, 516, 520, and 524 can indicate this feedback. An alert box 600 can also provide feedback as shown in FIG. 6. In some embodiments, the alert box 600 are used for instances in which a requested transaction cannot proceed.

FIG. 6 illustrates a screen shot of an alert box 600 for presenting an alert regarding an attempted financial transaction, according to an example embodiment. The alert box 600 can include various text strings or characters for imparting further information to a user. For example, the alert box 600 can provide a message 602. A reason 604 indicates why the transaction cannot proceed, and the reason 604 corresponds to a reason code 606. In some embodiments, the customer system 102 can use the reason code 606 to retrieve additional details from a relational database regarding the reason 604.

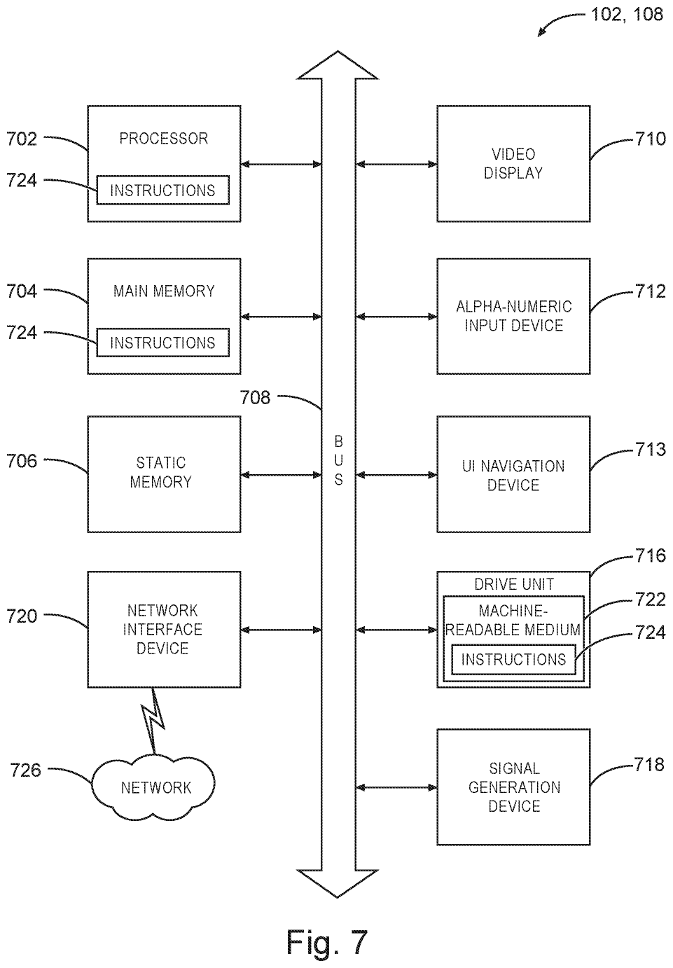

FIG. 7 is a block diagram illustrating components of the customer system 102 or the bank system 108 according to some example embodiments, able to read instructions from a machine-readable medium (e.g., a machine-readable storage medium) and perform any one or more of the methodologies discussed herein. Specifically, FIG. 7 shows a diagrammatic representation of the customer system 102 or the bank system 108 in the example form of a computer system and within which instructions 724 (e.g., software) for causing the customer system 102 or the bank system 108 to perform any one or more of the methodologies discussed herein can be executed.

In alternative embodiments, the customer system 102 or the bank system 108 operates as a standalone device or can be connected (e.g., networked) to other machines 622. In a networked deployment, the customer system 102 or the bank system 108 can operate in the capacity of a server machine or a client machine in a server-client network environment, or as a peer machine in a peer-to-peer (or distributed) network environment. The customer system 102 or the bank system 108 can be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine, Further, while only a single machine is illustrated, the term “machine” shall also be taken to include a collection of machines that individually or jointly execute the instructions 724 to perform any one or more of the methodologies discussed herein. For example, when acting as a customer system 102, the instructions 724 can cause customer system 102 to perform operations including retrieving a value from a transaction data field of a fund transfer request form responsive to an event notification that the transaction data field has been updated; providing the value to an external device; and receiving, from the external device and responsive to providing the value to the external device, an indicator of the likelihood that a transaction request corresponding to the fund transfer request form will be permitted. When acting as a bank system 108, the instructions 724 can cause the bank system 108 to perform operations including receiving a message, from an external device, that includes transaction data for a proposed transaction that has been proposed on the external device; generating an assessment, responsive to receiving the message and based at least in part on the transaction data, of the likelihood that the transaction will be permitted; and providing user feedback to the external device to indicate the likelihood.

The customer system 102 or bank system 108 includes at least one processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. Among other usages, the main memory 704 or static memory 706 can store database tables for querying operations related to bank accounts, governmental blacklists or other governmental databases, currency data, etc., as described earlier herein. The customer system 102 or bank system 108 can further include a graphics display 710 (e.g., a plasma display panel (PDP), a light emitting diode (LED) display, a liquid crystal display (LCD), a projector, or a cathode ray tube (CRT)), The graphics display 710 can display any data associated with bank accounts, such as account balances, advertisements for additional services, geographically specific data, etc. The customer system 102 or bank system 108 can also include an alphanumeric input device 712 (e.g., a keyboard), a cursor control device 713 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 (e.g., software) embodying any one or more of the methodologies or functions described herein. The instructions 724 can also reside, completely or at least partially, within the main memory 704, within the processor 702 (e.g., within the processor's cache memory), or both, during execution thereof by the customer system 102 or the bank system 108. Accordingly, the main memory 704 and the processor 702 can be considered as machine-readable media. The instructions 724 can be transmitted or received over a network 726 via the network interface device 720.

As used herein, the term “memory” refers to a machine-readable medium able to store data temporarily or permanently and can be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing instructions (e.g., software) for execution by a machine (e.g., the customer system 102 or the bank system 108 (FIG. 1)), such that the instructions, when executed by one or more processors of the machine (e.g., processor 702 or processors for the assessment system 107 (FIG. 1)), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Certain embodiments are described herein as including logic or a number of components, modules, or mechanisms. Modules can constitute either software modules (e.g., code embodied on a non-transitory machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a field programmable gate array (FPGA) or an ASIC. A hardware module can also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, a processor being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an application program interface (API)).

The performance of certain of the operations can be distributed among the one or more processors, not only residing within a single machine, but deployed across a number of machines. In some example embodiments, the one or more processors or processor-implemented modules can be located in a single geographic location (e.g., within a home environment, an office environment, or a server farm). In other example embodiments, the one or more processors or processor-implemented modules can be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities can take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like can refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance.

1. (canceled)

2. A method comprising:
presenting a user interface on a display device of a first computing device, the user interface including:
a first input field to receive first transaction data for a transaction;
a first likelihood of success visual indicator configured to provide a real time first success indication as the first transaction data is inputted in the first input field;
a second input field to receive second transaction data for the transaction;
a second likelihood of success visual indicator configured to provide a real time second success indication as the second transaction data is inputted in the second input field; and
an overall likelihood of success visual indicator configured to provide a real time overall success indicator for the transaction as the first transaction data and second transaction data is entered into the first input field and second input field; and
transmitting the first transaction data, as it is inputted into the first input field, to a second computing device;
receiving an assessment of the first transaction data, with respect to a chance of success for the transaction, from the second computing device; and
updating the first likelihood of success visual indicator and overall likelihood of success visual indicator based on the assessment.

3. The method of claim 2, wherein the transaction is a fund transfer request and wherein the first transaction data is a payee name and the second transaction data is an amount of payment.

4. The method of claim 3, wherein the first success indication is a color.

5. The method of claim 4, further comprising:
selecting the color to present as the first success indication based on the assessment indicating the amount of payment exceed a threshold.

6. The method of claim 2, wherein the overall likelihood of success visual indicator is based on a weighted assessment based on relative importance of first transaction data and the second transaction data.

7. The method of claim 2, wherein the user interface further includes a suggestion for amending the first transaction data when the assessment indicates the transaction cannot proceed.

8. The method of claim 2, wherein the first input field is configured to perform data integrity checking on the first transaction data.

9. A non-transitory computer-readable medium comprising instructions, which when executed by at least one processor, configure the at least one processor to perform operations comprising:
presenting a user interface on a display device of a first computing device, the user interface including:
a first input field to receive first transaction data for a transaction;
a first likelihood of success visual indicator configured to provide a real time first success indication as the first transaction data is inputted in the first input field;
a second input field to receive second transaction data for the transaction;
a second likelihood of success visual indicator configured to provide a real time second success indication as the second transaction data is inputted in the second input field; and
an overall likelihood of success visual indicator configured to provide a real time overall success indicator for the transaction as the first transaction data and second transaction data is entered into the first input field and second input field; and
transmitting the first transaction data, as it is inputted into the first input field, to a second computing device;
receiving an assessment of the first transaction data, with respect to a chance of success for the transaction, from the second computing device; and
updating the first likelihood of success visual indicator and overall likelihood of success visual indicator based on the assessment.

10. The non-transitory computer-readable medium of claim 9, wherein the transaction is a fund transfer request and wherein the first transaction data is a payee name and the second transaction data is an amount of payment.

11. The non-transitory computer-readable medium of claim 10, wherein the first success indication is a color.

12. The non--transitory computer-readable medium of claim 11, the operations further comprising:
selecting the color to present as the first success indication based on the assessment indicating the amount of payment exceed a threshold.

13. The non-transitory computer-readable medium of claim 9, wherein the overall likelihood of success visual indicator is based on a weighted assessment based on relative importance of first transaction data and the second transaction data.

14. The non-transitory computer-readable medium of claim 9, wherein the user interface further includes a suggestion for amending the first transaction data when the assessment indicates the transaction cannot proceed.

15. The non-transitory computer-readable medium of claim 9, wherein the first input field is configured to perform data integrity checking on the first transaction data.

16. A system comprising:
at least one processor;
a storage device comprising instructions, which when executed by the at least one processor, configure the at least one processor to perform operations comprising:
presenting a user interface on a display device of a first computing device, the user interface including:
a first input field to receive first transaction data for a transaction;
a first likelihood of success visual indicator configured to provide a real time first success indication as the first transaction data is inputted in the first input field;
a second input field to receive second transaction data for the transaction;
a second likelihood of success visual indicator configured to provide a real time second success indication as the second transaction data is inputted in the second input field; and
an overall likelihood of success visual indicator configured to provide a real time overall success indicator for the transaction as the first transaction data and second transaction data is entered into the first input field and second input field; and
transmitting the first transaction data, as it is inputted into the first input field, to a second computing device;
receiving an assessment of the first transaction data, with respect to a chance of success for the transaction, from the second computing device; and
updating the first likelihood of success visual indicator and overall likelihood of success visual indicator based on the assessment.

17. The system of claim 16, wherein the transaction is a fund transfer request and wherein the first transaction data is a payee name and the second transaction data is an amount of payment.

18. The system of claim 17, wherein the first success indication is a color.

19. The system of claim 18, the operations further comprising:
selecting the color to present as the first success indication based on the assessment indicating the amount of payment exceed a threshold.

20. The system of claim 16, wherein the overall likelihood of success visual indicator is based on a weighted assessment based on relative importance of first transaction data and the second transaction data.

21. The system of claim 16, wherein the user interface further includes a suggestion for amending the first transaction data when the assessment indicates the transaction cannot proceed.
